(19) United States
(12) Patent Application Publication
(10) Pub. No.: US 2009/0132533 A1
(43) Pub. Date: May 21, 2009

(54) Hierarchical Sequencer For Pseudo-Hierarchical Table

(75) Inventor: Peter Vignet, San Francisco, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SAP AG

(21) Appl. No.: 11/943,284

(22) Filed: Nov. 20, 2007

(51) Int. Cl. G06F 17/30; G06F 7/08

(52) U.S. Cl. 707/7; 707/101; 707/E17.044

(57) ABSTRACT

A system and process that restores the hierarchy whether explicit or pseudo-hierarchy after it has been lost due to filtering, grouping or similar manipulation of table data. The system and process store the hierarchy upon loading of the table. The user can manipulate the table data and use an input mechanism such as a button to trigger the restoration of the hierarchy. The restoration of the hierarchy rearranges entries to restore a hierarchy such as parent/child relationships without disturbing other effects of the user manipulation of data.

### BACKGROUND

1. Field of the Invention

The invention relates to table management. Specifically, the embodiments of the invention relate to a method and system for reorganizing tables to re-establish a hierarchy or pseudo-hierarchy through a component that is application and backend implementation independent.

2. Background

Tables are utilized in a large number of different applications. The applications include spreadsheet applications such as EXCEL® by Microsoft Corporation of Redmond, Wash., supply chain management applications such as SCM by SAP AG of Waldorf, Germany, database applications such as MySQL by MySQL AB of Uppsala, Sweden and similar applications. These applications access stored data, draw a table and insert the data into the table.

Tables can be divided into hierarchical tables and flat tables. Both types of tables include a set of related data presented as entries, which typically correspond to rows in the table. The table data is divided into a set of rows and columns. The columns indicate different types of data associated with each entry or row. Hierarchical tables have entries with a set of relationships, typically parent-child relationships. The ordering of rows in the database is based on the parent-child relationships of entries with parent entries being placed above the child entries. In hierarchical tables the parent-child relationship is encoded in a set of fields or columns of each entry. The application then uses these fields to order the entries.

Flat tables do not have an explicitly encoded hierarchy. However, flat tables can have a hierarchy that is an inherent or pseudo-hierarchy. A table may be loaded or drawn to place columns in a specific order that indicates hierarchy. For example, columns with a high number of repeated values may be placed to the left of columns with a lower number of repeated values. The repeated values and associated entries can be sorted to group the repeated values together. Further order can be exposed by grouping repeated values into single fields across multiple entries. This presentation of data exposes relationships between the data across different entries.

The ordering of data to show hierarchy including explicit and pseudo-hierarchy is performed by the application that draws and displays the tables. As a result, each application must separately implement this functionality. Implementing this functionality also requires that the application interact with the backend implementation, such as a database management system or file system, to access and store data when maintaining or updating the order of the data in the tables.

### SUMMARY

Embodiments of the invention include a system and process that restores the hierarchy whether explicit or pseudo-hierarchy after it has been lost due to filtering, grouping or similar manipulation of table data. The system and process store the hierarchy upon loading of the table. The user can manipulate the table data and use an input mechanism such as a button to trigger the restoration of the hierarchy. The restoration of the hierarchy rearranges entries to restore a hierarchy such as parent/child relationships without disturbing other effects of the user manipulation of data.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of a system for providing an application independent and backend implementation independent hierarchy restoration.

FIG. 2 is a flowchart of one embodiment of a process for loading a table.

FIG. 3 is a flowchart of one embodiment of a process for restoring table hierarchy.

FIG. 4 is a diagram of one embodiment of a flat table in an original order.

FIG. 5 is a diagram of one embodiment of a sorted flat table.

FIG. 6 is a diagram of one embodiment of a sorted flat table.

FIG. 7 is a flowchart of one embodiment of a process for restoring hierarchy order.

### DETAILED DESCRIPTION

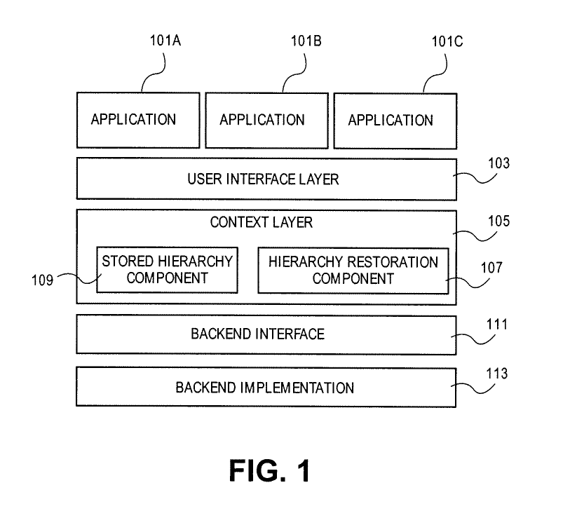

FIG. 1 is a diagram of a system for providing an application independent and backend implementation independent hierarchy restoration. The system can include any number of applications 101A-C, a user interface layer 103, a context layer 105, a backend interface 111 and a backend implementation 113. One skilled in the art would appreciate that the illustrated components are abstracted and could be implemented through any number of components in the form of software components, hardware components and combinations thereof.

The applications 101A-C can be any type of applications including word processing programs, spreadsheet applications, supply chain management applications, database management applications and similar types of applications that utilize and rely on tables to display sets of data to a user. A set, as used herein, refers to any positive whole number of items including one item. The system can include any number of applications 101A-C that can be executed by a single computer system or a set of computer systems. The applications 101A-C rely on a user interface layer 103 to generate basic aspects of the application interface.

The user interface layer 103 can be a library, set of classes or similar components that are utilized by applications to generate basic user interface elements such windows, menus, icons and similar user interface elements. The user interface layer 103 is implemented separately from the applications 101A-C to allow for reuse of the functionality of the user interface layer 103 across applications to provide a consistent style and to simplify programming requirements. The user interface layer 103 can be exposed to applications through an application programming interface (API) or similar interface, set of classes or library. The user interface layer 103 can be provided as part of an operating system, programming platform or environment such as Java® by Sun Microsystems of Santa Clara, Calif. or similar software.

The context layer 105 can be a library, set of classes or similar components that are utilized by applications to provide a software environment to the applications, including providing functionality and data to the user of the applications. The context layer 105 can store data including user data, environment data and similar data. The context layer 105 can also include a stored hierarchy component 109 and a hierarchy restoration component 107.

A stored hierarchy component 109 can store hierarchy, including explicit and pseudo-hierarchy, information for each table that is loaded by the applications 101A-C. A separate instance of a stored hierarchy component 109 can be created for each table that is loaded by an application. In another embodiment, a set of stored hierarchy components 109 store the hierarchy data for multiple tables. The stored hierarchy component 109 can be in the form of or include any data structure including hash tables, lists, objects and similar data structures. The stored hierarchy component 109 may be stored in a system memory or similar storage device.

A hierarchy restoration component 107 is a class, library, object or similar component that is accessible by applications 101A-C, other context layer component and the user interface layer 103. The hierarchy restoration component 107 receives calls from the applications 101A-C, context layer components or user interface layer 103 that indicate a table to be reorganized. The indicator can be a parameter or similar method of passing information between programs, processes, objects or similar structures. The indicator can be an object representing the table data, a link or pointer to the table data, an identifier for the table data or similar representation of the table data. The hierarchy restoration component 107 looks up or similarly retrieves hierarchy information for the table represented by the indicator in the appropriate stored hierarchy component 109. The hierarchy restoration component 107 then sorts and reorders the table data according to the retrieved hierarchy data. The table data is then returned to the requesting application 101A-C, context layer component or to the user interface layer 103 to be redrawn or displayed to the user.

The backend interface (I/F) 111 is an abstraction of the communication components that allow the context layer 105, user interface layer 103 and applications 101A-C to communicate with a backend implementation 113. The backend interface 111 can be implemented using any combination of remote function calls (RFC), remote procedure calls (RPC), open database connectivity (ODBC), Java® database connectivity (JDBC) or similar backend communication and interfacing technologies. The backend interface 111 can vary depending on the type of backend implementation 113. In one embodiment, multiple backend systems 113 can be utilized. Each backend system 113 can have a separate backend interface 111 or share any combination of backend interfaces 111.

The backend implementation 113 can be any server such as a database management system, file system, web server or similar program. The backend implementation 113 provides and manages data utilized by the applications 101A-C including application and user data. The backend implementation 113 can store table data, customization data, user data and similar types of data to be accessed by the applications 101A-C. The backend implementation 113 can be local to the machines executing the applications 10A-C or remote from the machines executing the applications 101A-C. The backend implementation 113 can exchange data with the applications through the backend interface 111. The data provided by the backend implementation 113 is stored on fixed disks, such as hard drives, optical drives and similar storage systems. As a result, the access times for the data provided by the backend implementation 113 can be on the order of milliseconds, seconds or longer. Thus, it can be advantageous to minimize the number of times that the backend implementation is accessed to improve performance of the applications 101A-C.

The context layer 105 improves overall system performance including application 101A-C performance by storing data such as the stored hierarchy component 107 and performing functions such as the hierarchy restoration. Storing this data locally and performing these functions independent of the backend implementation 113 minimizes the number of accesses to the backend implementation 113.

The components of the context layer 105 are independent of the backend implementation 113 and the applications 101A-C. Thus, the applications 101A-C do not have to replicate the functionality of the context layer 105 components or manage the storage of the data in the context layer 105. Similarly, the applications 101A-C do not have to communicate with the backend implementation 113 to retrieve and manipulate the hierarchy data to maintain or restore table hierarchy.

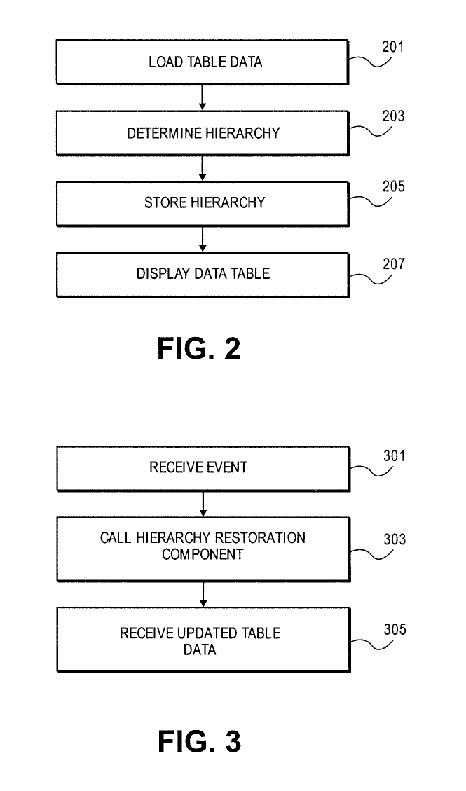

FIG. 2 is a flowchart of one embodiment of a process for loading a table. The process can be executed by a stored hierarchy component, application, user interface, or similar component or any combination of these components. An application receives an input from a user that requires the display of table data. This input can be the opening of a file, project, the application itself of similar input. The application then generates a request to the user interface layer, context layer or backend interface to load the table to be displayed to a user (block 201).

The backend implementation responds to the request by returning the table data. The application, context layer or user interface layer determines the hierarchy of the table (block 203). The hierarchy can be explicit or pseudo-hierarchy. The determination of the hierarchy can vary dependent on the table data. An explicit hierarchy can be discerned by retrieving values within the loaded fields that identify each entry and the hierarchy for each entry. A pseudo-hierarchy can be discerned by retrieving values within the loaded fields that inherently identify entries, column order, parent/child related fields or a similar set of fields. In one embodiment, a complete copy of each table is stored at the time it is loaded to be utilized for determining hierarchy for later restoration. In another embodiment, a representation of the hierarchy of the entries is stored in the context layer.

The hierarchy, whether in the form of a complete table or a representation of a table, is stored in a stored hierarchy component (block 205). A stored hierarchy component can be a set of data structures or objects that receive the table as a parameter and store it for later retrieval. In one embodiment, a new instance of a stored hierarchy component can be created to store each loaded table. The table data can be removed when the table data is no longer used by the application, for example, when the application is closed. In another embodiment, a representation of the table hierarchy is stored in a data structure such as a hash table, linked list or similar data structure.

The loaded table data is then returned to the user interface and application to draw and display the table (block 207). The application then allows a user to modify and rearrange the loaded table data. The table hierarchy can be lost during use, but can be restored because it has been stored in the stored hierarchy component at the time it was loaded.

FIG. 3 is a flowchart of one embodiment of a process for restoring table hierarchy. In one embodiment, a user can direct that an original hierarchy be restored to a particular table through a user interface mechanism such as a menu, button or similar input mechanism. The interaction of the user with this input mechanism generates an event to be handled or passed to a hierarchy restoration component (block 301). The event can include an indicator of the table for which the user wants the hierarchy restored. One skilled in the art would understand that the use of an event is an example embodiment and that the process could be initiated through a function call, interrupt, method call or similar process. The implementation as an event and within an object oriented system is described for sake of clarity.

In one embodiment, a hierarchy restoration component executes in response to receiving an event or call from an application or the user interface layer (block 303). The method for invoking the hierarchy restoration component can vary dependent on the implementation of the component. For example, the component can be implemented as a set of objects with methods available to applications or as listeners for specific events generated within the system such as the accessing of table data.

The application receives the table data or an indicator such as a pointer or link to the table data with the hierarchy restored in response to the call or event (block 303). The application or user interface layer can then redraw the table for the user to display the table with the original hierarchy reestablished.

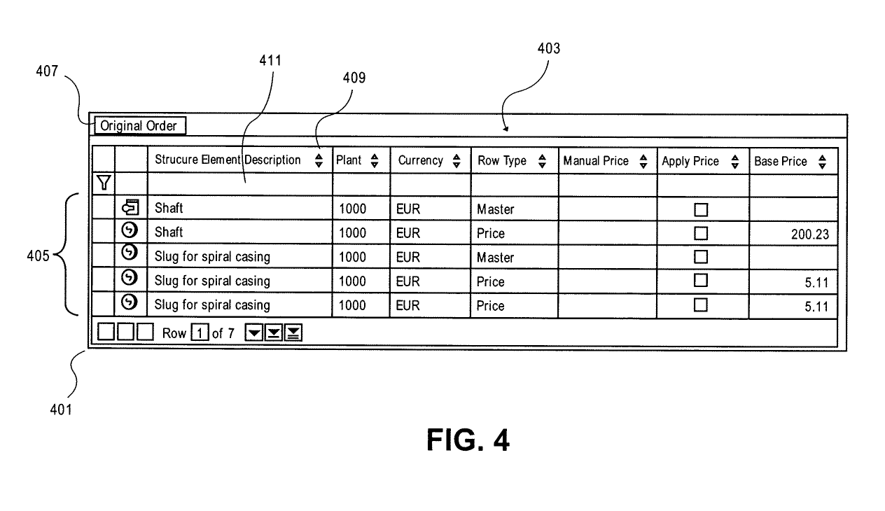

FIG. 4 is a diagram of one embodiment of a flat table in an initial order. The diagram shows an example table 401 in its original order, i.e. the order at the time it was loaded. In the example, the table 401 has been drawn to display seven entries 405. The entries each include a set of fields including ‘structure element description,’ plant,’ ‘currency,’ ‘row type,’ ‘manual price,’ ‘apply price’ and ‘base price.’ A table can have any number or rows, columns and entries.

In the example, the table, although a flat table, has a pseudo-hierarchy that is based on the row type field/column 403. The entries are ordered such that parent entries are listed before child entries. An input mechanism 407 is presented to allow a user to activate the hierarchy restoration component and restore the original table order. The table data can be reorganized by sorting columns (e.g., by selecting the arrows 409 in any column header), filtering the entries (e.g., by entering criteria in the filter fields 411) or similarly modifying the data displayed.

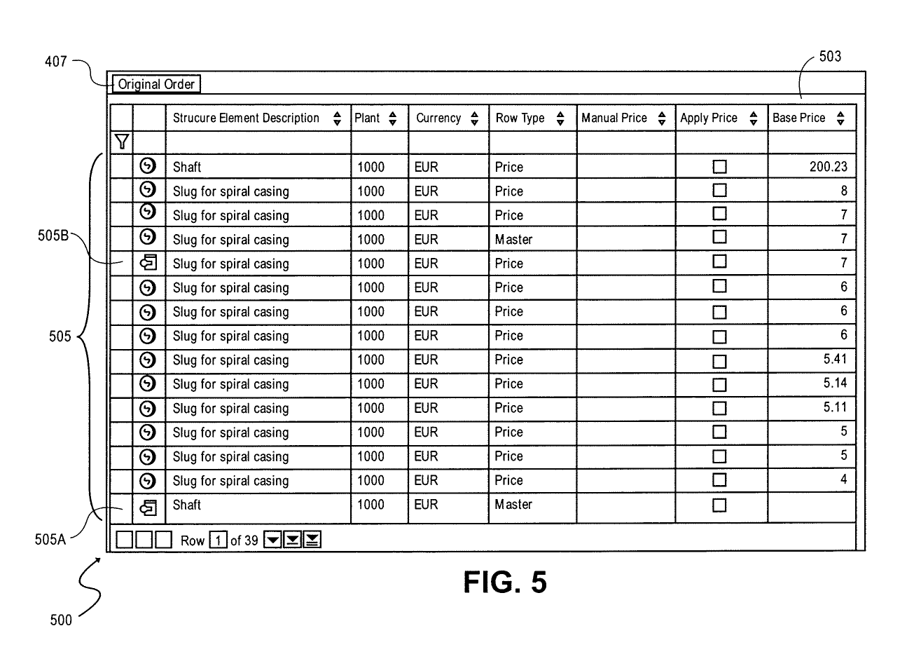

FIG. 5 is a diagram of one embodiment of a sorted flat table. The table 500 is an expanded version of the example table of FIG. 4. The table has been sorted on its last column ‘base price.’ The largest base price entry has been moved to the top row and the lowest base price entry has been moved to the last row. After the sort, the pseudo-hierarchy has been lost. The entries 505 are no longer ordered with the parent entries preceding the child entries. For example, the two parent entries 505A, B are separated from their child entries or in the midst of their child entries and are ordered based on the value in their ‘base price’ field. In this circumstance a user can select the original order button to restore the parent/child relationship without otherwise disturbing the sorted order.

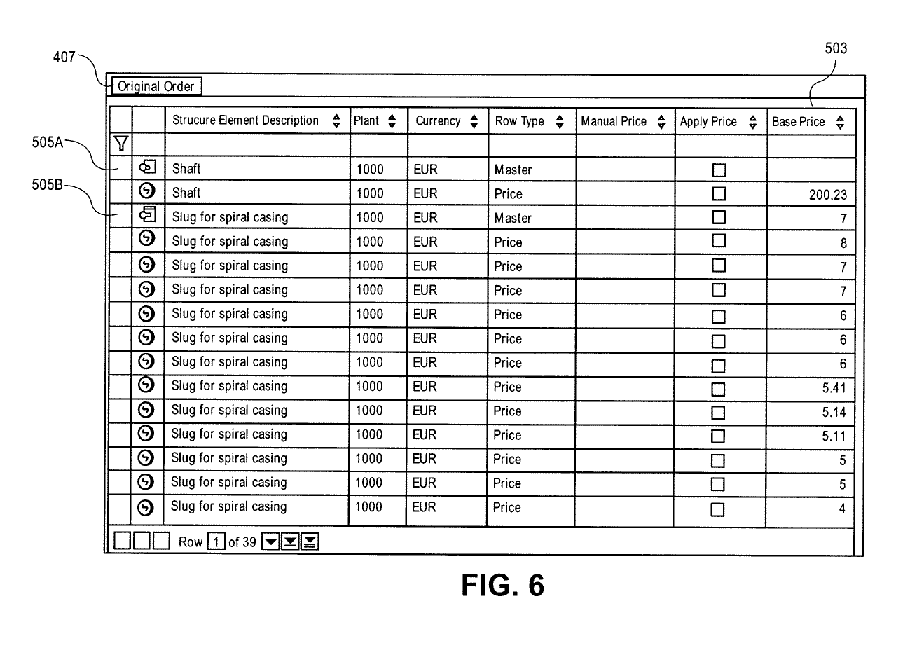

FIG. 6 is a diagram of one embodiment of a sorted flat table with a restored hierarchy. A user can restore the hierarchy by using the original order button 407 or similar input mechanism. The application presenting the table calls the hierarchy restoration component to resort the table and restore the original hierarchy. The original order button 407 can be placed in the window of a table, in a menu or similarly made available to a user. The user interface layer can provide the input mechanism and generate an event or call the hierarchy restoration component upon selection.

The hierarchy restoration component returns the table data with the hierarchy restored but otherwise leaving the modified order of the table intact. In the illustrated example of FIG. 6, the parent entries 505A, 505B have been repositioned to precede their respective child entries. However, the order of the child entries has been maintained and still reflects the sorting of the entries based on the ‘base price’ column 503.

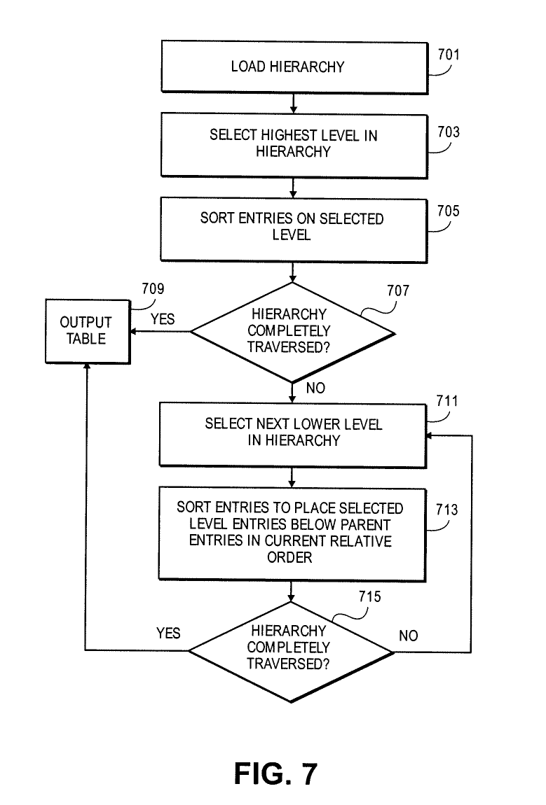

FIG. 7 is a flowchart of one embodiment of a process for restoring hierarchy order. In one embodiment, the process for restoring hierarchy order is performed by a hierarchy restoration component that is both backend and application independent. The process receives an indicator of a table to be restored to its original order. In another embodiment, any number of stored hierarchies including explicit or pseudo-hierarchies can be stored for each table. A user can select which of the hierarchies to restore. The selected hierarchy is retrieved from a stored hierarchy component (block 701). For sake of convenience, the hierarchy to be restored is assumed to be the hierarchy at the time the table was first loaded, referred to herein as the original hierarchy.

The hierarchy restoration component then determines the highest level in the hierarchy to be restored (block 703). The hierarchy restoration component can determine the highest level in an explicit hierarchy by look up of the fields encoding the order. The hierarchy restoration component can determine the highest level in a pseudo-hierarchy by parent/child relationships in the table data. The parent/child relationships may be found in particular fields of each entry. In one embodiment, the user can specify the parent/child relationship or similar relationship by specifying the relevant field or set of fields.

The entries of the table are first sorted on the highest level of entries in the table data (block 705). Each of the entries at the highest level can be sorted to have their original relative order or can be maintained in their current relative order. Thus, the highest level entries are sorted and separated from the lower level entries. The entries can be placed in a separate table that is created to replace the table being restored or moved within the table to be restored.

A check is made after completion of the sorting on the highest level of the table (block 707). If all of the hierarchy levels have been completely traversed then the table can be output or returned to the requesting application (block 709). If all of the hierarchy levels have not been completely traversed, then the next lower level in the hierarchy can be selected for sorting (block 709).

The entries at the next level are then sorted and placed after their respective parent entries (block 711). The sorting does not alter the relative order of child entries of the same parent. Each of the entries is traversed to determine if it is a child of an already sorted level and placed in order after the parent. A test is then made to determine if the sorted hierarchy level is the last level (block 713). If the hierarchy has been exhausted, then the reordered table is output to the calling application (block 709) to be displayed to the user. If the hierarchy has been If the hierarchy has not been exhausted, then next level is selected (block 709) and sorted (block 711). This process continues until the hierarchy has been exhausted and the table is then returned to the calling application.

In one embodiment, the hierarchy restoration system may be implemented as hardware devices. In another embodiment, these components may be implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a call indicating a table by a hierarchy restoration component;
retrieving a stored hierarchy for the table from a data structure separate from the table and hierarchy restoration component;
reorganizing the table to have the stored hierarchy; and
returning a reorganized table requesting application.

2. The method of claim 1, further comprising:
maintaining relative entry order within the stored hierarchy during reorganization.

3. The method of claim 1, further comprising:
sorting the table to restore an order of the highest level in the stored hierarchy.

4. The method of claim 1, further comprising:
sorting the table to place child entries after parent entries.

5. The method of claim 4, further comprising:
placing the child entries after the parent in current relative order.

6. The method of claim 1, further comprising:
sorting the table to restore an order of a next highest level in the stored hierarchy without disturbing the highest level order.

7. The method of claim 2, wherein the reorganized table is returned after traversal of a pseudo hierarchical structure of the table.

8. The method of claim 1, wherein the hierarchy restoration component is application and back end independent.

9. The method of claim 1, further comprising:
storing a current configuration of the table; and
restoring the current configuration of the table after reorganization to the store hierarchy.

10. A machine readable medium, having instructions stored therein, which when executed cause the machine to perform a set of operations, comprising:
retrieving a stored hierarchy for input table data from a data structure in local memory by an application independent hierarchy restoration component;
reorganizing the input table data to conform to the stored hierarchy; and
outputting reorganized table data.

11. The machine readable medium of claim 10, having further instructions stored therein, which when executed cause the machine to perform a further set operations comprising:
maintaining relative entry order of the input table data within the stored hierarchy during reorganization.

12. The machine readable medium of claim 10, having further instructions stored therein, which when executed cause the machine to perform a further set operations comprising:
sorting the input able to restore an order of the highest level in the stored hierarchy.

13. The machine readable medium of claim 10, having further instructions stored therein, which when executed cause the machine to perform a further set operations comprising:
sorting the input table data to place child entries after parent entries according to the stored hierarchy.

14. The machine readable medium of claim 13, having further instructions stored therein, which when executed cause the machine to perform a further set operations comprising:
placing the child entries after the parent entries in current relative order.

15. The machine readable medium of claim 10, having further instructions stored therein, which when executed cause the machine to perform a further set operations comprising:
sorting the input table data to restore an order of a next highest level in the stored hierarchy without disturbing the highest level order.

16. The machine readable medium of claim 2, wherein reorganized table data is returned after traversal of a pseudo hierarchical structure of the input table data.

17. The machine readable medium of claim 1, further comprising:
storing the hierarchy during initial loading of the table.

18. The machine readable medium of claim 10, having further instructions stored therein, which when executed cause the machine to perform a further set operations comprising:
storing a current configuration of the input table data; and
restoring the current configuration of the input table data after reorganization to the store hierarchy.

19. A system comprising:
a user interface component to draw a table for an application;
a context component comprising,
a hierarchy storage component, and
a hierarchy restoration component; and
a backend interface component to retrieve and store table data for the table in a database component.

20. The system of claim 19, wherein the context component is local to the user interface component and the application.
